(19) United States
(12) Patent Application Publication
(10) Pub. No.: US 2021/0232801 A1
(43) Pub. Date: Jul. 29, 2021

(54) MODEL-BASED ITERATIVE RECONSTRUCTION FOR FINGERPRINT SCANNER

(71) Applicant: QUALCOMM Incorporated, San Diego, CA (US)

(72) Inventors: Hasib SIDDIQUI, San Diego, CA (US); Nathan Felix ALTMAN, San Diego, CA (US); Kwokleung CHAN, Sunnyvale, CA (US)

(21) Appl. No.: 16/985,735

(22) Filed: Aug. 5, 2020

Related U.S. Application Data
(60) Provisional application No. 62/966,888, filed on Jan. 28, 2020.

(51) Int. Cl. G06K 9/00; G06T 7/00; G06T 5/00; G06T 5/50; G06F 3/041; G06F 3/043; G06F 3/042; G06F 21/32; G06N 3/08; G06N 7/00

(52) U.S. Cl. CPC G06K 9/00087; G06T 2207/20221; G06K 9/0004; G06T 7/0012; G06T 5/001; G06T 5/50; G06F 3/04166; G06F 3/0418; G06F 3/043; G06F 3/0425; G06F 21/32; G06N 3/08; G06N 7/005; G06T 2207/20084; G06T 2207/20076; G06T 2207/20081; G06K 9/0002

(57) ABSTRACT

Various aspects of the present disclosure generally relate to wireless communication. In some aspects, a device may receive, from a fingerprint scanner, fingerprint scan data associated with an image that depicts a scanned fingerprint of a user; process, using a model-based iterative reconstruction (MBIR) model, the fingerprint scan data to generate an enhanced image associated with the image; and perform, based at least in part on the enhanced image, a match analysis to authenticate the user. Numerous other aspects are provided.

### CROSS-REFERENCE TO RELATED APPLICATION

This Patent Application claims priority to provisional U.S. Provisional Patent Application No. 62/966,888, filed on Jan. 28, 2020, entitled “MODEL-BASED ITERATIVE RECONSTRUCTION FOR FINGERPRINT SCANNER,” and assigned to the assignee hereof. The disclosure of the prior Application is considered part of and is incorporated by reference into this Patent Application.

### FIELD OF THE DISCLOSURE

Aspects of the present disclosure generally relate to a fingerprint scanner and to a model-based iterative reconstruction for a fingerprint scanner.

### BACKGROUND

Fingerprint scanners have been included in devices such as smartphones, cash machines, cars, and/or the like. The fingerprint scanners may be utilized to authenticate a user. A typical fingerprint scanner (e.g., an ultrasonic fingerprint scanner, an optical fingerprint scanner, and/or the like) has a function of capturing an image (or a plurality of images) of a fingerprint of a user for authentication.

### SUMMARY

In some aspects, a method may include receiving, by a device and from a fingerprint scanner, fingerprint scan data associated with an image that depicts a scanned fingerprint of a user; processing, by the device and using a model-based iterative reconstruction (MBIR) model, the fingerprint scan data to generate an enhanced image associated with the image; and performing, by the device and based at least in part on the enhanced image, a match analysis associated with authenticating the user.

In some aspects, a method may include training a signal model to process an image based at least in part on an image quality metric associated with the image; configuring a sensor model based at least in part on calibration information associated with the fingerprint scanner; and configuring an optimization model to enhance the image based at least in part on the signal model and the sensor model.

In some aspects, a method may include receiving a plurality of images that depict a fingerprint; processing, using an image fusion model, the plurality of images to generate a fused image; determining whether an image quality metric associated with the fused image satisfies a threshold quality; and when the image quality metric satisfies the threshold quality: performing, based at least in part on the fused image, a match analysis associated with authenticating a user, or when the image quality metric does not satisfy the threshold quality: processing the fused image using a model-based iterative reconstruction to generate an enhanced image associated with the fused image; and performing, based at least in part on the enhanced image, a match analysis associated with authenticating the user.

In some aspects, a method may include receiving, by a device and from a fingerprint scanner, fingerprint scan data associated with the image; determining, by the device, a noisy estimate of a pixel of the image, wherein the noisy estimate is determined based at least in part on a sensor model associated with the fingerprint scanner and a pixel value of the pixel in the fingerprint scan data; iteratively determining, by the device, projection values of the pixel until a final projection value of the projection values corresponds to a final estimate of the pixel, wherein the projection values are determined based at least in part on the noisy estimate, a signal model, and the sensor model; and changing, by the device, the pixel value of the fingerprint scan data to the final projection value to enhance the image.

In some aspects, a device may include one or more memories, and one or more processors, communicatively coupled to the one or more memories, configured to: receive, by a device and from a fingerprint scanner, fingerprint scan data associated with an image that depicts a scanned fingerprint of a user; process, by the device and using an MBIR model, the fingerprint scan data to generate an enhanced image associated with the image; and perform, by the device and based at least in part on the enhanced image, a match analysis associated with authenticating the user.

In some aspects, a device may include one or more memories, and one or more processors, communicatively coupled to the one or more memories, configured to: train a signal model to process an image based at least in part on an image quality metric associated with the image; configure a sensor model based at least in part on calibration information associated with the fingerprint scanner; and configure an optimization model to enhance the image based at least in part on the signal model and the sensor model.

In some aspects, a device may include one or more memories, and one or more processors, communicatively coupled to the one or more memories, configured to: receive a plurality of images that depict a fingerprint; process, using an image fusion model, the plurality of images to generate a fused image; determine whether an image quality metric associated with the fused image satisfies a threshold quality; and when the image quality metric satisfies the threshold quality: perform, based at least in part on the fused image, a match analysis associated with authenticating a user, or when the image quality metric does not satisfy the threshold quality: process the fused image using a model-based iterative reconstruction to generate an enhanced image associated with the fused image; and perform, based at least in part on the enhanced image, a match analysis associated with authenticating the user.

In some aspects, a device may include one or more memories, and one or more processors, communicatively coupled to the one or more memories, configured to: receive, by a device and from a fingerprint scanner, fingerprint scan data associated with the image; determine, by the device, a noisy estimate of a pixel of the image, wherein the noisy estimate is determined based at least in part on a sensor model associated with the fingerprint scanner and a pixel value of the pixel in the fingerprint scan data; iteratively determine, by the device, projection values of the pixel until a final projection value of the projection values corresponds to a final estimate of the pixel, wherein the projection values are determined based at least in part on the noisy estimate, a signal model, and the sensor model; and change, by the device, the pixel value of the fingerprint scan data to the final projection value to enhance the image.

In some aspects, a non-transitory computer-readable medium may store one or more instructions. The one or more instructions, when executed by one or more processors of a device, may cause the one or more processors to: receive, by a device and from a fingerprint scanner, fingerprint scan data associated with an image that depicts a scanned fingerprint of a user; process, by the device and using an MBIR model, the fingerprint scan data to generate an enhanced image associated with the image; and perform, by the device and based at least in part on the enhanced image, a match analysis associated with authenticating the user.

In some aspects, a non-transitory computer-readable medium may store one or more instructions. The one or more instructions, when executed by one or more processors of a device, may cause the one or more processors to: train a signal model to process an image based at least in part on an image quality metric associated with the image; configure a sensor model based at least in part on calibration information associated with the fingerprint scanner; and configure an optimization model to enhance the image based at least in part on the signal model and the sensor model.

In some aspects, a non-transitory computer-readable medium may store one or more instructions. The one or more instructions, when executed by one or more processors of a device, may cause the one or more processors to: receive a plurality of images that depict a fingerprint; process, using an image fusion model, the plurality of images to generate a fused image; determine whether an image quality metric associated with the fused image satisfies a threshold quality; and when the image quality metric satisfies the threshold quality: perform, based at least in part on the fused image, a match analysis associated with authenticating a user, or when the image quality metric does not satisfy the threshold quality: process the fused image using a model-based iterative reconstruction to generate an enhanced image associated with the fused image; and perform, based at least in part on the enhanced image, a match analysis associated with authenticating the user.

In some aspects, a non-transitory computer-readable medium may store one or more instructions. The one or more instructions, when executed by one or more processors of a device, may cause the one or more processors to: receive, by a device and from a fingerprint scanner, fingerprint scan data associated with the image; determine, by the device, a noisy estimate of a pixel of the image, wherein the noisy estimate is determined based at least in part on a sensor model associated with the fingerprint scanner and a pixel value of the pixel in the fingerprint scan data; iteratively determine, by the device, projection values of the pixel until a final projection value of the projection values corresponds to a final estimate of the pixel, wherein the projection values are determined based at least in part on the noisy estimate, a signal model, and the sensor model; and change, by the device, the pixel value of the fingerprint scan data to the final projection value to enhance the image.

In some aspects, an apparatus may include means for receiving, by a device and from a fingerprint scanner, fingerprint scan data associated with an image that depicts a scanned fingerprint of a user; means for processing, by the device and using an MBIR model, the fingerprint scan data to generate an enhanced image associated with the image; and means for performing, by the device and based at least in part on the enhanced image, a match analysis associated with authenticating the user.

In some aspects, an apparatus may include means for training a signal model to process an image based at least in part on an image quality metric associated with the image; means for configuring a sensor model based at least in part on calibration information associated with the fingerprint scanner; and means for configuring an optimization model to enhance the image based at least in part on the signal model and the sensor model.

In some aspects, an apparatus may include means for receiving a plurality of images that depict a fingerprint; means for processing, using an image fusion model, the plurality of images to generate a fused image; means for determining whether an image quality metric associated with the fused image satisfies a threshold quality; and when the image quality metric satisfies the threshold quality: means for performing, based at least in part on the fused image, a match analysis associated with authenticating a user, or when the image quality metric does not satisfy the threshold quality: means for processing the fused image using a model-based iterative reconstruction to generate an enhanced image associated with the fused image; and means for performing, based at least in part on the enhanced image, a match analysis associated with authenticating the user.

In some aspects, an apparatus may include means for receiving, by a device and from a fingerprint scanner, fingerprint scan data associated with the image; means for determining, by the device, a noisy estimate of a pixel of the image, wherein the noisy estimate is determined based at least in part on a sensor model associated with the fingerprint scanner and a pixel value of the pixel in the fingerprint scan data; means for iteratively determining, by the device, projection values of the pixel until a final projection value of the projection values corresponds to a final estimate of the pixel, wherein the projection values are determined based at least in part on the noisy estimate, a signal model, and the sensor model; and means for changing, by the device, the pixel value of the fingerprint scan data to the final projection value to enhance the image.

Aspects generally include a method, apparatus, system, computer program product, non-transitory computer-readable medium, user device, wireless communication device, and/or processing system as substantially described with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram conceptually illustrating an example system in which devices and/or methods described herein may be implemented, in accordance with various aspects of the present disclosure.

FIG. 2 is a diagram conceptually illustrating example components of one or more devices shown in FIG. 1, such as a user device, in accordance with various aspects of the present disclosure.

FIGS. 3A, 3B, and 4-7 are diagrams conceptually illustrating examples associated with a model-based iterative reconstruction (MBIR) for a fingerprint scanner in accordance with various aspects of the present disclosure.

FIGS. 8-11 are flowcharts of example processes associated with an MBIR for a fingerprint scanner, in accordance with various aspects of the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based at least in part on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

In many instances, a user device (e.g., a user equipment, a smartphone, a tablet computer, and/or the like) may include a fingerprint scanner (e.g., to unlock the user device based at least in part on a scan of a user's fingerprint). For example, the fingerprint scanner may be an ultrasonic fingerprint scanner, an optical fingerprint scanner, and/or the like, that provides one or more signals, associated with a scan of the fingerprint, that are used to obtain and/or generate fingerprint scan data. The fingerprint scan data may be represented and/or analyzed as an image of the fingerprint. The fingerprint scan data and/or image of the fingerprint may then be compared with reference fingerprint data (e.g., fingerprint data generated based at least in part on a scan of a fingerprint of one or more authorized users of a user device) to permit the user device to perform an action based at least in part on whether the fingerprint scan data matches the reference fingerprint data (e.g., perform/prevent an unlock operation, perform/prevent a log in operation, allow/deny user access according to a user authentication operation, and/or the like).

However, in some instances, a poor coupling between a user finger and a fingerprint scanner platen (e.g., when a user applies a finger to or presses a finger on the fingerprint scanner) results in a low resolution scan that may correspondingly result in an inaccurate match analysis. For example, the poor coupling may cause a reduction of a signal-to-noise ratio (SNR) of captured fingerprint images that prevents the fingerprint matcher from being able to accurately match an authorized user's fingerprint scan to reference fingerprint data of the authorized user. Such a poor coupling may be caused by certain conditions of the fingerprint scan (e.g., a dry finger condition where a user's finger does not have enough moisture to enable a strong coupling against the fingerprint platen).

In some previous techniques, to improve the resolution of an image of a fingerprint, multiple sets of fingerprint scan data, corresponding to multiple images of the user's fingerprint, can be obtained during a single fingerprint scan operation. The multiple sets of fingerprint scan data (and/or images) may be fused (referred to as “temporal image fusion”) to improve accuracy of a match analysis. However, such techniques can be relatively compute intensive (e.g., require relatively large amounts of processing resources, memory resources, and/or the like), increase latency associated with providing the fingerprint scan data and/or performing the match operation (e.g., due to obtaining multiple sets of fingerprint scan data, processing the multiple images, and/or fusing the multiple images into a single set of fingerprint scan data), and waste computing resources (e.g., processing resources, memory resources, and/or the like) associated with inaccurately determining a mismatch between fingerprint scan data of an authorized user with corresponding reference fingerprint data for the authorized user.

Some aspects described herein use a model-based iterative reconstruction (MBIR) process to improve fingerprint image reconstruction. For example, a user device may include an MBIR model that includes and/or utilizes a sensor model and a signal model. The sensor model is configured based at least in part on one or more characteristics of the fingerprint scanner and/or user device (e.g., characteristics determined according to a calibration of the fingerprint scanner and/or user device). The signal model may include a machine learning model (e.g., a convolutional neural network (CNN) and/or other type of neural network) associated with signals (and/or data) associated with one or more fingerprint scans of the fingerprint scanner. As described herein, the user device and/or image enhancement model may utilize an optimization technique (e.g., an alternating direction method of multipliers (ADMM) technique) to converge values of pixels of an image to an optimal estimate (e.g., according to the optimization technique and/or the image enhancement model). In this way, the user device (and/or image enhancement model) reduces, relative to previous techniques, inaccurate fingerprint scans and/or analyses (e.g., false rejections) for low resolution images, reduces latency of a fingerprint scan of a low resolution image, and conserves and/or prevents wasting computing resources associated with false rejections and/or other inaccurate fingerprint scans or analyses.

According to one or more aspects described herein, one or more artificial intelligence techniques, including machine learning, deep learning, neural networks, and/or the like can be used to process and/or enhance an image (e.g., an image that depicts a fingerprint). For example, the image enhancement model may use a computer vision technique, such as a CNN technique to assist in classifying image data (e.g., image data including representations of fingerprints and/or the like) into a particular class. More specifically, the image enhancement model may determine that a depicted fingerprint has relatively more or relatively less noise. Furthermore, the image enhancement model may be configured to analyze image data to determine whether a fingerprint represented in the image data is associated with an authorized user (e.g., based on a lookup and/or matching operation).

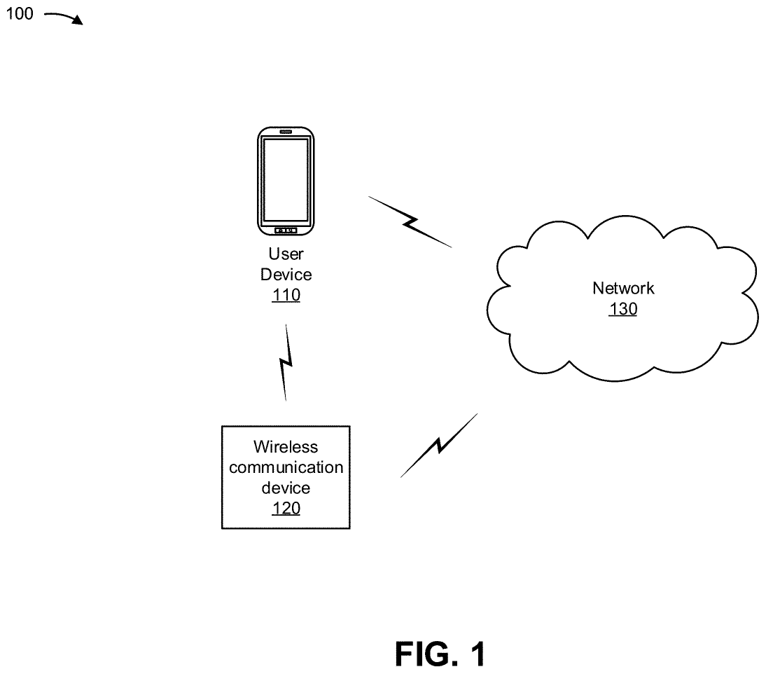

FIG. 1 is a diagram conceptually illustrating an example system 100 in which devices and/or methods described herein may be implemented, in accordance with various aspects of the present disclosure. As shown in FIG. 1, system 100 may include a user device 110, a wireless communication device 120, and/or a network 130. Devices of system 100 may interconnect via wired connections, wireless connections, or a combination of wired and wireless connections.

User device 110 includes one or more devices capable of including one or more input components associated with an MBIR model for a fingerprint scanner, as described herein. For example, user device 110 may include one or more devices capable of receiving, generating, storing, processing, and/or providing information associated with one or more sensors (e.g., capacitive touch sensors, accelerometers, piezoelectric sensors, ultrasonic sensors, and/or the like) for detecting a user described herein. More specifically, user device 110 may include a communication and/or computing device that includes a capacitive touch interface (e.g., a touchscreen, a capacitive touch button, and/or the like), such as a user equipment (e.g., a smartphone, a radiotelephone, and/or the like), a laptop computer, a tablet computer, a handheld computer, a wearable communication device (e.g., a smart wristwatch, a pair of smart eyeglasses, and/or the like), a home security system (e.g., with a touch controlled security panel), a home appliance, a vehicle (e.g., which has capacitive touch controlled doors, consoles, and/or the like), a payment terminal, an Internet of Things (IoT) device, or any other similar type of device. As described herein, user device 110 (and/or a user detection module of user device 110) may include a fingerprint scanner and/or an MBIR model that is to process one or more images of a fingerprint captured by a fingerprint scanner to enhance the one or more images for a fingerprint analysis (e.g., to match the fingerprint to a reference fingerprint), as described herein.

Similar to user device 110, wireless communication device 120 includes one or more devices capable of receiving, generating, storing, processing, and/or providing information associated with a user input and/or user interaction described herein. For example, wireless communication device 120 may include a base station, an access point, and/or the like. Additionally, or alternatively, similar to user device 110, wireless communication device 120 may include a communication and/or computing device, such as a mobile phone (e.g., a smart phone, a radiotelephone, and/or the like), a laptop computer, a tablet computer, a handheld computer, a desktop computer, a gaming device, a wearable communication device (e.g., a smart wristwatch, a pair of smart eyeglasses, and/or the like), or a similar type of device.

Network 130 includes one or more wired and/or wireless networks. For example, network 130 may include a cellular network (e.g., a long-term evolution (LTE) network, a code division multiple access (CDMA) network, a 3G network, a 4G network, a 5G network, another type of next generation network, and/or the like), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks. In some aspects, network 130 may include a data network and/or be communicatively with a data platform (e.g., a web-platform, a cloud-based platform, a non-cloud-based platform, and/or the like) that is capable of receiving, generating, processing, and/or providing information associated with a user input and/or user interaction detected and/or analyzed by user device 110.

The number and arrangement of devices and networks shown in FIG. 1 are provided as one or more examples. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) of system 100 may perform one or more functions described as being performed by another set of devices of system 100.

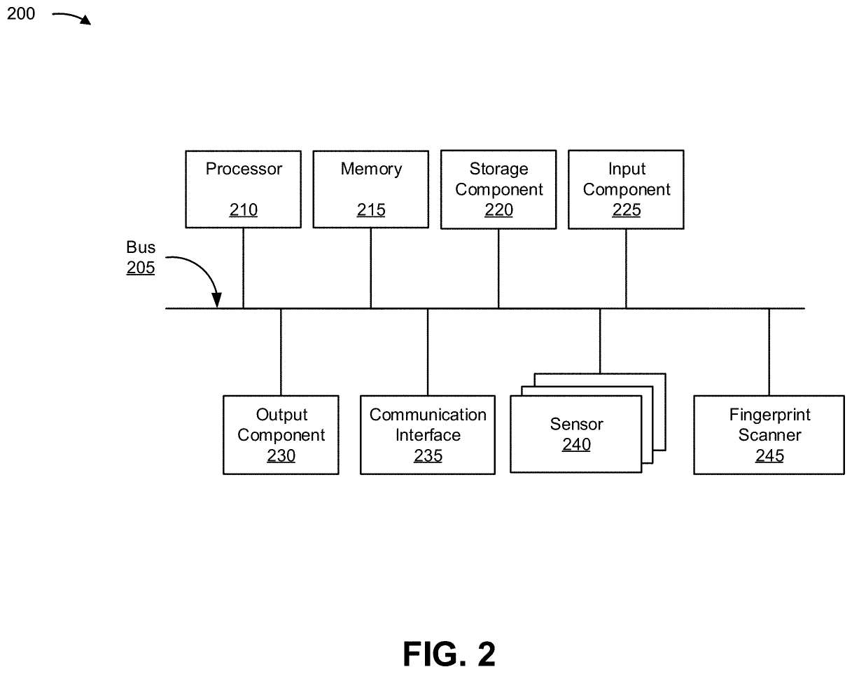

FIG. 2 is a diagram of example components of a device 200. Device 200 may correspond to user device 110 and/or wireless communication device 120. Additionally, or alternatively, user device 110, and/or wireless communication device 120 may include one or more devices 200 and/or one or more components of device 200. As shown in FIG. 2, device 200 may include a bus 205, a processor 210, a memory 215, a storage component 220, an input component 225, an output component 230, a communication interface 235, one or more sensors 240 (referred to individually as a “sensor 240” and collectively as “sensors 240”), and a fingerprint scanner 245.

Bus 205 includes a component that permits communication among the components of device 200. Processor 210 includes a central processing unit (CPU), a graphics processing unit (GPU), an accelerated processing unit (APU), a digital signal processor (DSP), a microprocessor, a microcontroller, a field-programmable gate array (FPGA), an application-specific integrated circuit (ASIC), and/or another type of processing component. Processor 210 is implemented in hardware, firmware, or a combination of hardware and software. In some aspects, processor 210 includes one or more processors capable of being programmed to perform a function.

Memory 215 includes a random-access memory (RAM), a read only memory (ROM), and/or another type of dynamic or static storage device (e.g., a flash memory, a magnetic memory, and/or an optical memory) that stores information and/or instructions for use by processor 210.

Storage component 220 stores information and/or software related to the operation and use of device 200. For example, storage component 220 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium, along with a corresponding drive.

Input component 225 includes a component that permits device 200 to receive information, such as via user input. For example, input component 225 may be associated with a user interface as described herein (e.g., to permit a user to interact with the one or more features of device 200). Input component 225 includes a capacitive touchscreen display that can receive user inputs. Input component 225 may include a keyboard, a keypad, a mouse, a button, a switch, a microphone, and/or the like. Additionally, or alternatively, input component 225 may include a sensor for sensing information (e.g., a vision sensor, a location sensor, an accelerometer, a gyroscope, an actuator, and/or the like). In some aspects, input component 225 may include a camera (e.g., a high-resolution camera, a low-resolution camera, and/or the like). In some aspects, input component 225 may include correspond to, and/or be associated with one or more of sensors 240. Output component 230 includes a component that provides output from device 200 (e.g., a display, a speaker, one or more light-emitting diodes (LEDs), and/or the like).

Communication interface 235 includes a transceiver and/or a separate receiver and transmitter that enables device 200 to communicate with other devices, such as via a wired connection, a wireless connection, or a combination of wired and wireless connections. Communication interface 235 may permit device 200 to receive information from another device and/or provide information to another device. For example, communication interface 235 may include an Ethernet interface, an optical interface, a coaxial interface, an infrared interface, a radio frequency (RF) interface, a universal serial bus (USB) interface, a Wi-Fi interface, a cellular network interface, a wireless modem, an inter-integrated circuit (I²C), a serial peripheral interface (SPI), or the like.

Sensor 240 includes one or more devices capable of sensing characteristics associated with device 200 (e.g., characteristic of a physical environment or operating condition of device 200). Sensor 240 may include one or more integrated circuits (e.g., on a packaged silicon die) and/or one or more passive components of one or more flex circuits to enable communication with one or more components of device 200.

Sensor 240 may include a vision sensor (e.g., an image sensor, an optical sensor, a camera, and/or the like) that has a field of view from which sensor 240 may obtain an image (e.g., an image of a fingerprint). Additionally, or alternatively, sensor 240 may include a hydrometer (e.g., to detect the presence or density of a liquid in an environment of device 200), a magnetometer (e.g., a Hall effect sensor, an anisotropic magnetoresistive (AMR) sensor, a giant magneto-resistive sensor (GMR), and/or the like), a location sensor (e.g., a global positioning system (GPS) receiver, a local positioning system (LPS) device (e.g., that uses triangulation, multi-lateration, and/or the like), and/or the like), a gyroscope (e.g., a micro-electro-mechanical systems (MEMS) gyroscope or a similar type of device), an accelerometer, a speed sensor, a motion sensor, an infrared sensor, a temperature sensor, a pressure sensor, a gas sensor, and/or the like.

Sensor 240 may include an ultrasonic sensor to detect the presence of a user and/or be used in association with ultrasonic fingerprint detection. In some aspects, the ultrasonic sensor may be used by fingerprint scanner 245 to obtain an ultrasonic measurement of a fingerprint of a user. As described herein, an ultrasonic sensor, as a passive sensor, may detect and/or analyze vibrations from a user that can be used to passively detect the user based at least in part on piezoelectric properties of the ultrasonic sensor (e.g., without transmitting an ultrasonic signal). An ultrasonic sensor, as an active ultrasonic sensor, may transmit an ultrasonic signal and receive a corresponding reflected ultrasonic signal that can be measured to determine whether the user's finger is on (or near) the user device, a touchscreen of the user device, and/or a fingerprint scanner of the user device.

Fingerprint scanner 245 includes one or more devices capable of analyzing a fingerprint of a user. Fingerprint scanner 245 may be associated with and/or communicatively coupled with one or more of sensors 240. Fingerprint scanner 245 may include and/or be associated with an optical sensor, an ultrasonic sensor, a capacitive touch sensor, a thermal sensor, and/or the like. Fingerprint scanner 245 may be configured, using any suitable technique, as a user authentication device to analyze a fingerprint of a user to determine whether the user is an authorized user of device 200 and/or an application associated with device 200. Accordingly, as an authentication device, fingerprint scanner 245 may, based at least in part on identifying a fingerprint of an authorized user, permit an unlock operation of the user device to be performed (e.g., to access an application of the user device, to access a home screen of the user device, to log in to an account associated with the user, and/or the like).

Device 200 may perform one or more processes described herein. Device 200 may perform these processes in response to processor 210 executing software instructions stored by a non-transitory computer-readable medium, such as memory 215 and/or storage component 220. “Computer-readable medium” as used herein refers to a non-transitory memory device. A memory device includes memory space within a single physical storage device or memory space spread across multiple physical storage devices.

Software instructions may be read into memory 215 and/or storage component 220 from another computer-readable medium or from another device via communication interface 235. When executed, software instructions stored in memory 215 and/or storage component 220 may cause processor 210 to perform one or more processes described herein. Additionally, or alternatively, hardwired circuitry may be used in place of or in combination with software instructions to perform one or more processes described herein. Thus, aspects described herein are not limited to any specific combination of hardware circuitry and software.

In some aspects, device 200 includes means for performing one or more processes described herein and/or means for performing one or more operations of the processes described herein. For example, the means for performing the processes and/or operations described herein may include bus 205, processor 210, memory 215, storage component 220, input component 225, output component 230, communication interface 235, sensor 240, and/or any combination thereof.

The number and arrangement of components shown in FIG. 2 are provided as an example. In practice, device 200 may include additional components, fewer components, different components, or differently arranged components than those shown in FIG. 2. Additionally, or alternatively, a set of components (e.g., one or more components) of device 200 may perform one or more functions described as being performed by another set of components of device 200.

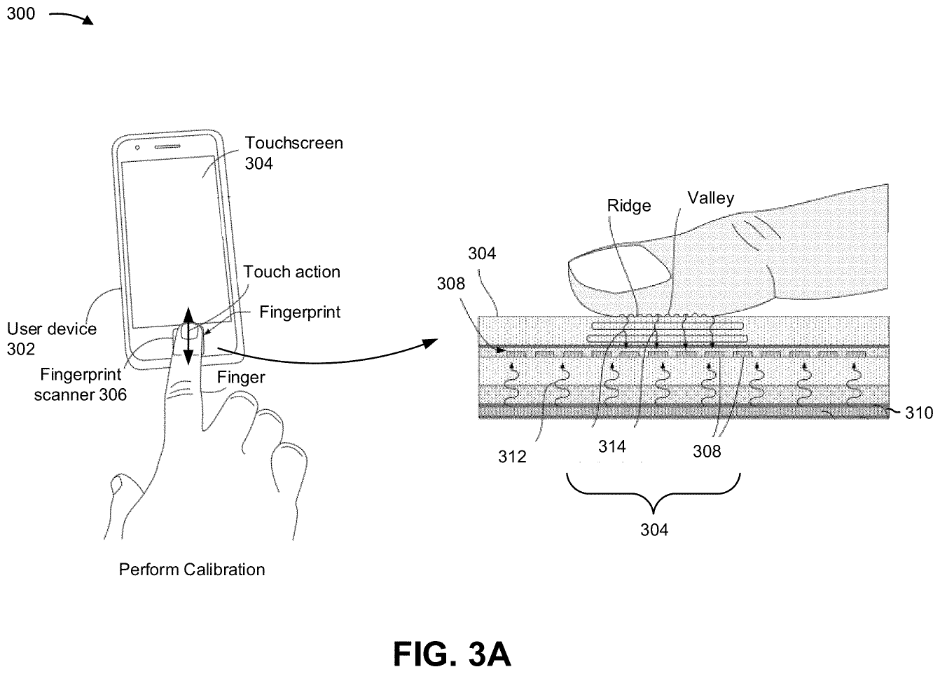

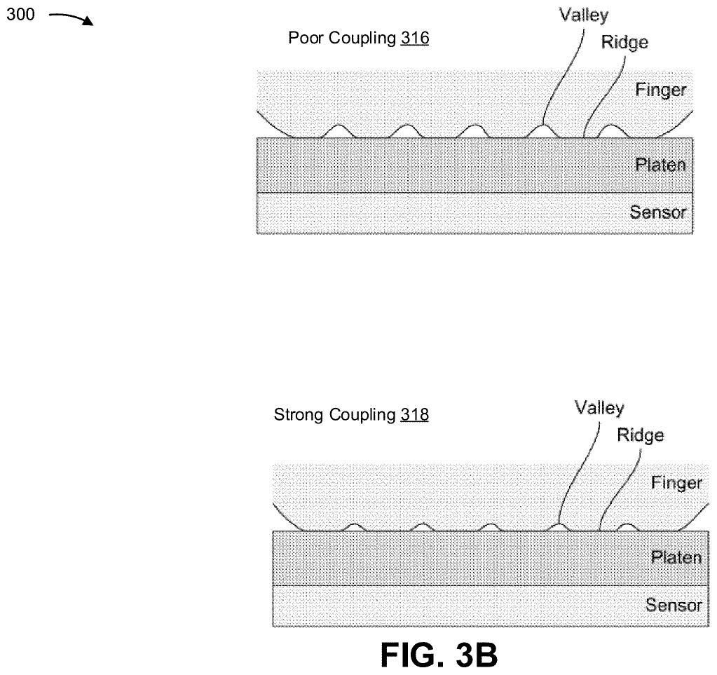

FIGS. 3A and 3B are diagrams conceptually illustrating an example 300 associated with a user device 302 in accordance with various aspects of the present disclosure. In example 300, user device 302 (which may correspond to user device 110 of FIG. 1) includes a touchscreen 304 (e.g., that includes an array of capacitive touch sensors) and a fingerprint scanner 306.

As described herein, during a scan of a fingerprint, the fingerprint scanner 306 may obtain fingerprint scan data that corresponds to an image of the fingerprint. During a scan, one or more sets of fingerprint data corresponding to one or more separate images may be obtained. In some aspects, when multiple sets of fingerprint scan data are obtained (and correspondingly, multiple images) from a scan, the multiple sets of fingerprint scan data may be combined (e.g., using a temporal image fusion process) to generate a single image of the fingerprint.

As shown in FIG. 3A, through a touch action of the user (represented by a hand of the user and/or finger of the user in FIGS. 3A and 3B) may provide a user input by touching or pressing a finger on the touchscreen 304 (e.g., to select a function of the user device 302) and/or the fingerprint scanner 306 (e.g., to permit the user device 302 to authenticate the user). As indicated in the cross-section view of a touch action over the fingerprint scanner 306, the fingerprint scanner 306 of example 300 includes ultrasonic sensing array 308 and an ultrasonic transmitter 310. Accordingly, the fingerprint scanner 306 may transmit ultrasonic waves 312 and receive reflected ultrasonic waves 314 from ridges and valleys of the finger. Correspondingly, the fingerprint scanner 306 may generate fingerprint scan data corresponding to received reflected ultrasonic waves 314 as sensed by the ultrasonic sensing array 308. Further, the fingerprint scanner 306 and/or the user device 302 may identify and/or analyze an image of the fingerprint via the reflected ultrasonic waves 314.

The ultrasonic sensing array 308 may include a plurality of individual sensing elements, each with unique physical characteristics (e.g., unique sizes, shapes, compositions, and/or the like). Accordingly, each sensing element, and further different individual user devices that include an ultrasonic sensing array similar to ultrasonic sensing array 308, may variably sense reflected ultrasonic waves. For example, different sensing elements in the ultrasonic sensing array 308 may have different point spread functions, different noise detection or noise tolerance capabilities, and/or the like. Therefore, one individual sensing element or user device may determine a different pixel value or capture a different image of a fingerprint than another sensing element or user device (despite being designed and/or manufactured to be the same) due to the variation in the physical characteristics of the sensing elements and/or user devices.

As shown in FIG. 3B, different types of conditions (e.g., environmental conditions, anatomical conditions, and/or the like) associated with the finger and/or user device may affect a coupling between the finger and a platen of the fingerprint sensor. As shown by reference number 316, a poor coupling may occur in which valleys of the finger are relatively far from the platen and/or less surface areas of the ridges are in contact with the platen. Such a poor coupling may occur when the finger has relatively low skin moisture, when operating under relatively cold conditions, and/or the like. Such a poor coupling increases the likelihood that the fingerprint scanner obtains a relatively low quality image of the fingerprint (e.g., an image that depicts a relatively large amount of noise corresponding to variations in pixel values between ridges and valleys and/or overlapping ridges and valleys). On the other hand, as shown by reference number 318, the valleys of the finger are relatively closer to the platen and relatively increased surface areas of the ridges are in contact with the platen to provide a strong coupling, which typically occurs under relatively optimal conditions, resulting in a relatively high quality image of the fingerprint.

Although the fingerprint scanner 306 is described in example 300 as being an ultrasonic fingerprint sensor, aspects described herein may similarly apply to other types of fingerprint scanners (e.g., optical, capacitive, thermal, and/or the like). As indicated above, FIGS. 3A and 3B are provided merely as one or more examples. Other examples may differ from what is described with regard to FIGS. 3A and 3B.

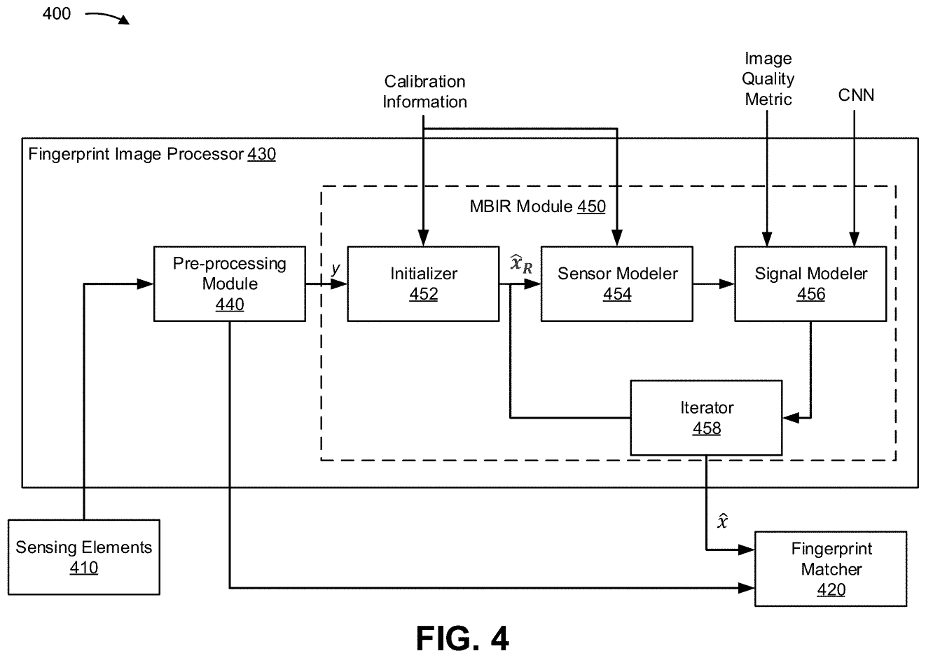

FIG. 4 is a diagram conceptually illustrating an example 400 of a fingerprint scanner (e.g., corresponding to fingerprint scanner 245 and/or fingerprint scanner 306) in accordance with various aspects of the present disclosure. As shown in FIG. 4, the fingerprint scanner includes sensing elements 410, a fingerprint matcher 420, and a fingerprint image processor 430. The fingerprint image processor 430 includes a preprocessing module 440 and an MBIR module 450 that includes an initializer 452, a sensor modeler 454, a signal modeler 456, and an iterator 458. One or more of the components and/or modules described in connection with example 400 may be included within and/or correspond to one or more of the components of device 200 of FIG. 2.

The sensing elements 410 may include one or more components configured to perform a scan of a fingerprint of a user and/or provide fingerprint scan data, as described herein. For example, the sensing elements may include one or more piezoelectric elements, such as polyvinylidene fluoride (PVDF) and polyvinylidene fluoride-trifluoroethylene (PVDF-TrFE) copolymers, polyvinylidene chloride (PVDC) homopolymers and copolymers, polytetrafluoroethylene (PTFE) homopolymers and copolymers, and diisopropylam-monium bromide (DIPAB). Sensing elements 410 may be included within and/or correspond to a thin film transistor (TFT). Sensing elements 410 may correspond to ultrasonic sensing array 308 of example 300.

Fingerprint matcher 420 may include one or more components or modules that are configured to compare fingerprint scan data and/or scanned images to reference data and/or reference images of fingerprints. Fingerprint matcher 420 may use any suitable matching technique and/or scoring system to determine a probability and/or likelihood that a scanned fingerprint matches a fingerprint associated with the reference data and/or a reference image (e.g., associated with an authorized user of the user device 302).

Preprocessing module 440 may include one or more components or modules configured to demodulate, analyze, and/or process an image of a fingerprint described herein. For example, preprocessing module 440 may include one or more filters and/or perform one or more filtering techniques. For example, the preprocessing module may be configured to identify and/or remove background content from the images (e.g., so that only content that depicts the fingerprint or that is within a perimeter of an identified fingerprint is remaining).

In some aspects, preprocessing module 440 may be configured to analyze and/or determine a quality of a depiction of a fingerprint. For example, preprocessing module 440 may be configured to identify noise within content that depicts the fingerprint based at least in part on variations in pixel values within the content. Correspondingly, preprocessing module 440 may determine an image quality metric associated with the image (e.g., using any suitable image quality scoring system).

In some aspects, preprocessing module 440 may be configured to perform a fusion technique to combine a plurality of images that depict a fingerprint. For example, during a single scan, the sensing elements 410 may obtain and/or provide a plurality of images of a fingerprint. Preprocessing module 440 may perform any suitable technique (e.g., utilizing a computer vision technique, an image processing technique, and/or the like) to combine the plurality of images into a single image (which may be referred to herein as a “fused image”). In some aspects, preprocessing module 440 may perform such a fusion technique based at least in part on the image quality metric not satisfying a threshold (e.g., a threshold corresponding to the image being relatively high quality or having a quality that would enable fingerprint matcher 420 to perform a fingerprint match analysis with a relatively high accuracy (e.g., an 80% probability of accuracy, a 90% probability of accuracy, a 95% probability of accuracy, and/or the like). In this way, if a relatively low quality image is received, the preprocessing module can perform a fusion technique (e.g., and/or request the sensing elements to obtain more images of the fingerprint) to obtain a fused image of the fingerprint that likely has a higher quality than an individual or initially received image of the fingerprint.

According to some aspects, when preprocessing module 440 determines that a received image (or a fused image) has an image metric that satisfies a threshold quality (e.g., that corresponds to a relatively high quality image), preprocessing module 440 may forward the image to the fingerprint matcher 420 for a fingerprint analysis (e.g., without further processing the image via MBIR module 450). In such cases, the preprocessing module 440 may conserve computing resources (e.g., processing resources and/or memory resources) that would be consumed by MBIR module 450.

MBIR module 450 may correspond to an MBIR model that utilizes initializer 452, sensor modeler 454, signal modeler 456, and iterator 458, as described herein. As described herein, MBIR module 450 may be utilized to enhance a preprocessed image (e.g., shown as or referred to as “y”). The preprocessed image may correspond to fingerprint scan data received from sensing elements 410 and/or preprocessing module 440. Accordingly, MBIR module 450 may be configured to enhance an image that is determined to be relatively low quality (e.g., according to preprocessing module 440). Additionally, or alternatively, MBIR module 450 may be configured to enhance a fused image that was generated by preprocessing module 440 from a plurality of images of a same fingerprint captured during a scan of the fingerprint by sensing elements 410.

Initializer 452 is configured to determine or make an initial estimate for a pixel of the image, a set of pixels of the image (e.g., a row of pixels that may be represented by a vector), or the image itself (e.g., as a vector). Initializer 452 may correspond to and/or include a sensor model that is configured to and/or defined by calibration information associated with the fingerprint scanner (e.g., associated with characteristics of sensing elements 410). For example, initializer 452 (and/or the sensor model) may be defined by a ridge regression model as follows:

y=Hx (1)

where y corresponds to the received pixel value or image vector, H corresponds to the sensor model and is defined by a Toeplitz matrix formed by a function h(n), and x corresponds to the estimated (or projected) pixel value or image vector that is used to enhance the image. More specifically, initializer 452 uses a spatially invariant sensor model, h(n), to perform an inversion. For example, an initial estimate \check{x}_{R} may be determined using the following:

$${\check{x}}_{R} ( ω ) = \frac{\check{h} ( ω ) \check{y} ( ω )}{\vert \check{h} ( ω ) {\vert}^{2} + β} \qquad ( 2 )$$

where a Fourier transform of y corresponds to:

$$\check{y} ( ω ) {↔}^{ℱ} y ( n ) \qquad ( 3 )$$

the sensor model corresponds to:

$$\check{h} ( ω ) {↔}^{ℱ} h ( n ) \qquad ( 4 )$$

and β is a regularization parameter.

Using the initial estimate, sensor modeler 454, signal modeler 456, and iterator 458, the MBIR module 450 may perform an optimization technique (e.g., a Lagrangian optimization) to determine an optimal estimate for pixel values to enhance a received low quality image. For example, such an optimization, as described herein, may be represented by:

$$\hat{x} = {arg min}_{x : x ∈ {ℝ}^{N}} {‖ y - Hx ‖}_{2}^{2} + β {g}_{α} ( x ) \qquad ( 5 )$$

where \hat{x} is determined to be an optimized output of the MBIR module 450. The sensor modeler 454 may process the least mean square of the sensor model H to move the solution in a direction that conforms with \hat{x}. The signal modeler 456 may correspond to processing g_{α}(x), which is a signal model that is configured to process the fingerprint scan data according to an image quality metric α. In this way, initial estimate \check{x}_{R} may correspond to x₀, and the iterator 458 may perform n iterations until a final MBIR estimate xₙ, corresponding to the optimized output \hat{x}, is found.

Further, MBIR module 450 may iteratively perform the optimization according to an alternating direction method of multipliers (ADMM) technique or other similar joint optimization technique to find a designated point between the sensor model and the signal model (e.g., an equilibrium point in each iteration). After determining the initial estimate \check{x}_{R}, as described above, the ADMM technique may be implemented by MBIR module 450 to process iterations via the sensor modeler 454, the signal modeler 456, and the iterator 458.

As an example, for a first iteration, with û=0 and \hat{v}=0, the signal modeler 456 may determine

$$\hat{x} = {arg min}_{x} {‖ y - Hx ‖}_{2}^{2} + β {‖ x - ( \hat{v} - \hat{u} ) ‖}_{2}^{2} \qquad ( 6 )$$

to project an estimate for a pixel value toward the sensor model H. In a second iteration, the signal modeler may determine:

z=Real(\hat{x}+û) (7)

and

\hat{v}=CNN_{α}(z) (8)

where CNN_{α} corresponds to a CNN that is based at least in part on the image quality metric α, and subsequently, values for û and \hat{v} are adjusted according to:

û=\hat{x}−\hat{v}+û (9)

to permit a subsequent iteration toward the signal model according to Equation 6. From there, the iterator 458 may cause the sensor modeler 454 and the signal modeler 456 to iterate through Equations 6 through 9 to converge to a value of a pixel at xₙ.

According to some aspects, the sensor modeler 454, when projecting the pixel value toward the sensor model h(n), may utilize:

$$\begin{matrix}\hat{x} ( n ) = {\hat{x}}_{R} ( n ) + {βℱ}^{- 1} \{ {\check{d}}_{i n v} ( ω ) ( \check{v} ( ω ) - \check{u} ( ω ) ) \} \\ where & ( 10 ) \\ \check{h} ( ω ) {↔}^{ℱ} h ( n ) & ( 11 ) \\ {\check{d}}_{i n v} ( ω ) = \frac{1}{\vert \check{h} ( ω ) {\vert}^{2} + β} & ( 12 )\end{matrix}$$

and where {ďᵢₙᵥ(ω)(\check{v}(ω)−\check{u}(ω))} is updated every iteration. Further, when projecting toward the sensor model, a regularized image can be found from:

$$\hat{v} ( n ) {↔}^{ℱ} \check{v} ( ω ) \qquad ( 13 )$$

and an ADMM residual value can be determined from:

$$\hat{u} ( n ) {↔}^{ℱ} \check{u} ( ω ) \qquad ( 14 )$$

until the iterator 458 determines that a designated quantity of iterations have been performed.

According to some aspects, the signal modeler 456 is to project the pixel value toward the signal model. For example, the signal modeler 456 may utilize

z(n)=Real{\hat{x}(n)+u(n)} (15)

and

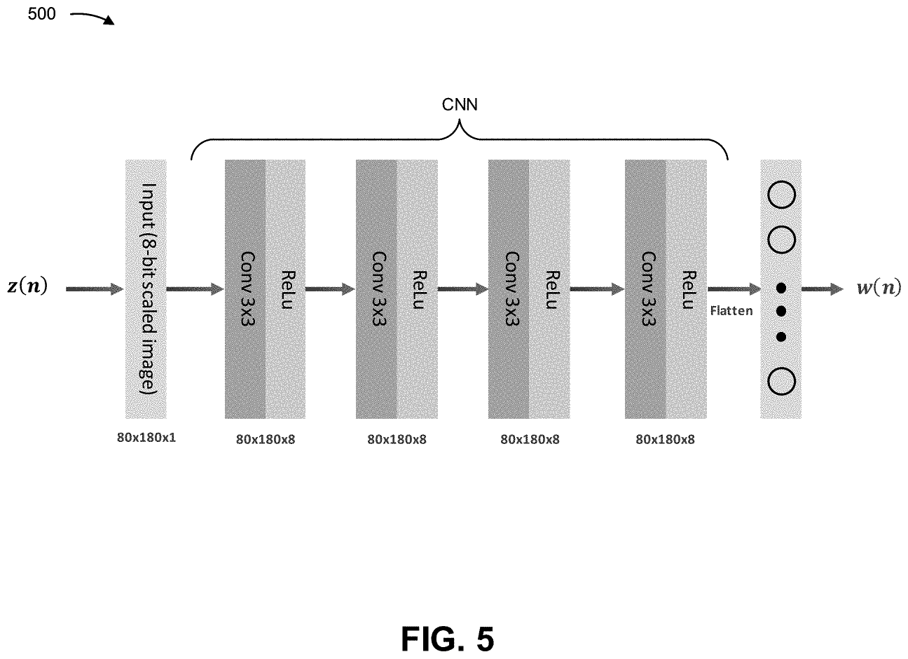

\hat{v}(n)=αz(n)+(1−α)w(n) (16)

where z(n) is an input to a CNN of the signal model and w(n) is a corresponding output from the CNN. For example, as shown in example 500 of FIG. 5, an image data z(n) (e.g., corresponding to an image captured by an 80×180×1 pixel array) is provided to a CNN to provide w(n), which corresponds to a projection on the signal model. The CNN may include one or more intermediate convolution layers to process pixel arrays of the image. Further, according to Equation 16, the image quality metric (e.g., which is on a scale of 0 to 1) determines whether the real image value is to be favored over the projected value from the CNN.

In some aspects, the CNN may be included and/or utilized in association with computer vision technique. Additionally, or alternatively, the computer vision technique may include using an image recognition technique (e.g., an Inception framework, a ResNet framework, a Visual Geometry Group (VGG) framework, and/or the like), an object detection technique (e.g. a Single Shot Detector (SSD) framework, a You Only Look Once (YOLO) framework, a cascade classification technique (e.g., a Haar cascade technique, a boosted cascade, a local binary pattern technique, and/or the like), and/or the like), an edge detection technique, an object in motion technique (e.g., an optical flow framework and/or the like), and/or the like. Additionally, or alternatively, the computer vision technique may include a lookup or matching technique configured to analyze the fingerprint of the user (e.g., to detect a particular pattern and/or reference points) to determine whether the user is an authorized user.

According to some aspects, the iterator 458 may determine a residual computation according to:

û(n)=\hat{x}(n)−\hat{v}(n)+û(n) (17)

for each iteration n. The quantity of iterations n may be fixed (e.g., according to a default or user setting). Additionally, or alternatively, the quantity of iterations may be dynamically determined according to a convergence of \hat{x}. For example, when a value for \hat{x} in a most recent iteration is within a threshold percentage of a value for \hat{x} in a next most recent iteration, the iterator 458 may determine that \hat{x} has converged to an optimal value, and the iterator outputs \hat{x} to enhance the image.

In some aspects, a training operation can be performed when generating a computer vision model, as described herein. For example, the computer vision model may include and/or correspond to the CNN, a noise reduction model (e.g., to filter out and/or remove noise from the image), a lookup model (e.g., for object recognition, for object detection, for pattern recognition, for match detection, and/or the like), and/or the like. In such a case, training data may be portioned into a training set (e.g., a set of data to train the computer vision model), a validation set (e.g., a set of data used to evaluate a fit of the model and/or to fine tune the model), a test set (e.g., a set of data used to evaluate a final fit of the model), and/or the like. In some aspects, the training data is generated (e.g., by adding noise, such as Gaussian noise, to an image) preprocessed and/or subjected to a dimensionality reduction (e.g., using a dimensionality reduction model to select and/or obtain samples of the training data) to reduce the a quantity of the training data to a minimum feature set (e.g., a set of pixel arrays). In some aspects, the computer vision model is trained on this minimum feature set, thereby reducing processing to train the computer vision model, and may apply a classification technique, to the minimum feature set.

In some aspects, a classification technique, such as a logistic regression classification technique, a random forest classification technique, a gradient boosting machine learning (GBM) technique, and/or the like, is used to determine a categorical outcome (e.g., that an image has a threshold quality, that an image does not have a threshold quality, and/or the like). Additionally, or alternatively, a naïve Bayesian classifier technique may be used. In this case, a binary recursive partitioning is performed to split the data of the minimum feature set into partitions and/or branches and use the partitions and/or branches to perform predictions (e.g., that the image is to be enhanced or not to be enhanced, that the image has been enhanced or has not been enhanced, and/or the like). Based on using recursive partitioning, a quantity and/or utilization of computing resources is reduced.

Additionally, or alternatively, a support vector machine (SVM) classifier technique can be used to generate a non-linear boundary between data items in the training set. In this case, the non-linear boundary is used to classify test data (e.g., data relating to high quality images of fingerprints, data relating to low quality images of fingerprints, and/or the like) into a particular class (e.g., a class indicating that the image is high quality, a class indicating that the image is low quality, and/or the like).

Additionally, or alternatively, the computer vision model may be trained using a supervised training procedure, a neural network technique, a latent semantic indexing technique, and/or the like. For example, computer vision model may be trained via an artificial neural network processing technique (e.g., using a two-layer feedforward neural network architecture, a three-layer feedforward neural network architecture, and/or the like) to perform pattern recognition with regard to patterns of whether an image includes a threshold amount of noise described. In this case, using the artificial neural network processing technique may improve an accuracy of the computer vision model by being more robust to noisy, imprecise, or incomplete data, and/or by enabling the fingerprint scanner and/or user device to detect patterns and/or trends.

In this way, aspects described herein may utilize one or more artificial intelligence techniques, one or more models, and/or the like to identify and/or enhance low quality images that depict a fingerprint.

As indicated above, FIGS. 4 and 5 are provided as one or more examples. Other examples may differ from what is described in connection with FIGS. 4 and 5.

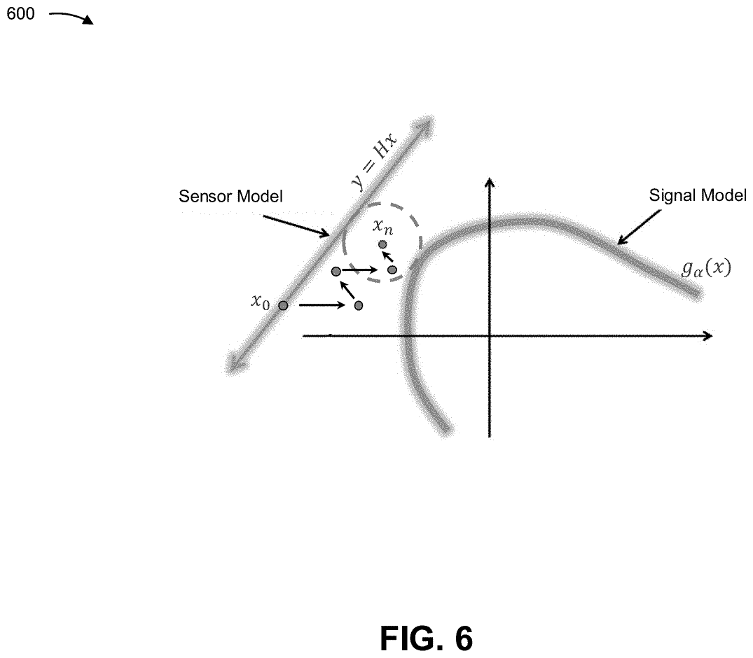

FIG. 6 is a diagram conceptually illustrating an example 600 associated with MBIR for a fingerprint scanner. In the example 600 of FIG. 6, the sensor model is shown as a linear model (y=Hx) and the signal model is shown as gₐ(x). As shown, four iterations may move a pixel value from an initial estimate x₀ along the sensor model to a final estimate xₙ that corresponds to an equilibrium point between the sensor model (which is specific to the sensor) and the signal model (which is specific to an image quality of the image of the fingerprint). As described herein, the final estimate xₙ for a pixel can be used to enhance an image relative to initial estimate xo and/or an originally provided pixel value in the fingerprint scan data.

As indicated above, FIG. 6 is provided as an example. Other examples may differ from what is described in connection with FIG. 6.

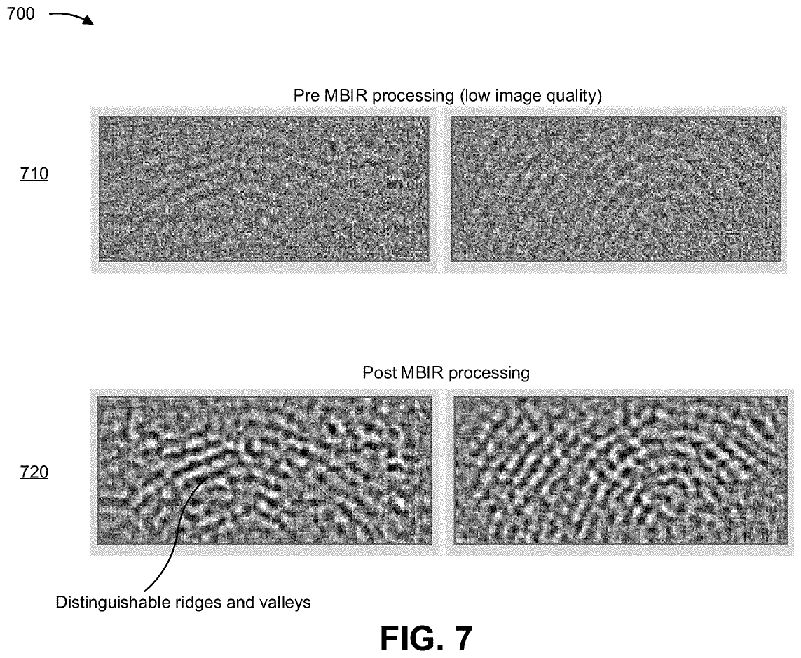

FIG. 7 is a diagram conceptually illustrating an example 700 associated with MBIR for a fingerprint scanner. As shown in FIG. 7, and by reference number 710, prior to an MBIR process being performed (e.g., by MBIR module 450) a pair of low quality images include indistinguishable depictions of ridges and valleys of a fingerprint. However, as shown by reference number 720, after an MBIR process is performed on the images, there are distinguishable ridges and valleys depicted in the images, thus providing an enhanced image that can be processed according to a match analysis.

As indicated above, FIG. 7 is provided as an example. Other examples may differ from what is described in connection with FIG. 7.

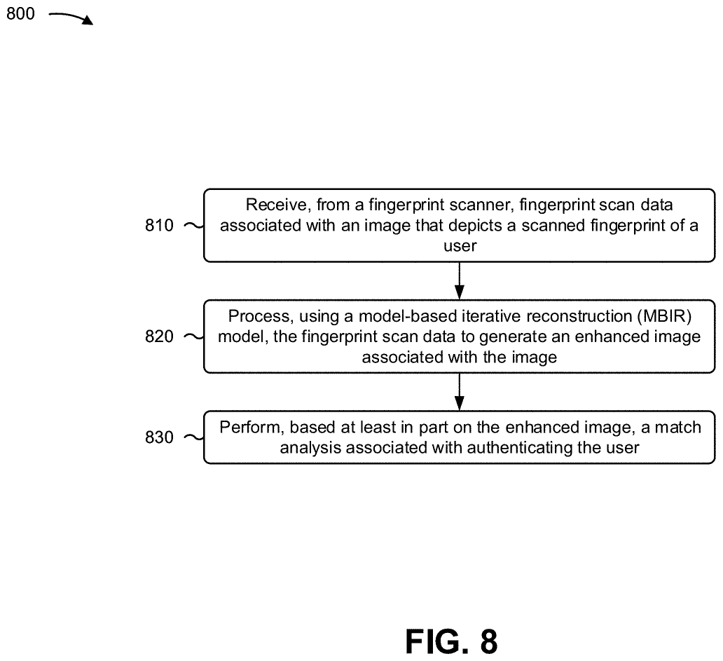

FIG. 8 is a diagram illustrating an example process 800 performed, for example, by a user device, in accordance with various aspects of the present disclosure. Example process 800 is an example where the user device (e.g., user device 110 and/or the like) utilizes MBIR for a fingerprint scanner.

As shown in FIG. 8, in some aspects, process 800 may include receiving, from a fingerprint scanner, fingerprint scan data associated with an image that depicts a scanned fingerprint of a user (block 810). For example, the user device (e.g., using processor 210, memory 215, storage component 220, input component 225, output component 230, communication interface 235, sensor 240, fingerprint scanner 245, and/or the like) may receive, from a fingerprint scanner, fingerprint scan data associated with an image that depicts a scanned fingerprint of a user, as described above.

As further shown in FIG. 8, in some aspects, process 800 may include processing, using an MBIR model, the fingerprint scan data to generate an enhanced image associated with the image (block 820). For example, the user device (e.g., using processor 210, memory 215, storage component 220, input component 225, output component 230, communication interface 235, sensor 240, fingerprint scanner 245, and/or the like) may process, using an MBIR model, the fingerprint scan data to generate an enhanced image associated with the image, as described above.

As further shown in FIG. 8, in some aspects, process 800 may include performing, based at least in part on the enhanced image, a match analysis associated with authenticating the user (block 830). For example, the user device (e.g., using processor 210, memory 215, storage component 220, input component 225, output component 230, communication interface 235, sensor 240, fingerprint scanner 245, and/or the like) may perform, based at least in part on the enhanced image, a match analysis associated with authenticating the user, as described above.

Process 800 may include additional aspects, such as any single aspect or any combination of aspects described below and/or in connection with one or more other processes described elsewhere herein.

In a first aspect, the fingerprint scanner includes an ultrasonic sensor, and the fingerprint scan data is associated with an ultrasonic signal of the ultrasonic sensor. In a second aspect, alone or in combination with the first aspect, the fingerprint scanner includes an optical sensor, and the fingerprint scan data is associated with an optical signal of the optical sensor.

In a third aspect, alone or in combination with one or more of the first and second aspects, the MBIR model includes a sensor model that is configured according to calibration information of the fingerprint scanner, and a signal model that is configured according to pixel values of the fingerprint scan data.

In a fourth aspect, alone or in combination with one or more of the first through third aspects, processing the fingerprint scan data may include, for a set of pixels of the image, iteratively: determining an initial estimate for a pixel value, of the fingerprint scan data, that is associated with a pixel of the set of pixels; and determining, for a quantity of iterations, projection estimates for the pixel value that is based at least in part on the initial estimate, the sensor model, and the signal model, wherein a final projection estimate of a final iteration of the quantity of iterations corresponds to a final estimate for the pixel and is used to generate the enhanced image.

In a fifth aspect, alone or in combination with one or more of the first through fourth aspects, the projection estimates are determined to be between a sensor pixel value defined by the sensor model and a signal pixel value defined by the signal model. In a sixth aspect, alone or in combination with one or more of the first through fifth aspects, the projection estimates are determined according to an alternating direction method of multipliers technique. In a seventh aspect, alone or in combination with one or more of the first through sixth aspects, the quantity of iterations is fixed. In an eighth aspect, alone or in combination with one or more of the first through seventh aspects, the quantity of iterations is based at least in part on an optimization model.

In a ninth aspect, alone or in combination with one or more of the first through eighth aspects, the MBIR model includes: a ridge regression model to determine initial noisy estimates for pixels of the image; a computer vision model to determine, based at least in part on the initial noisy estimates and an image quality metric associated with the image, enhanced estimates for pixels of the image; and an optimization model to determine, based at least in part on the enhanced estimates, final estimates for the pixels of the image that correspond to pixel values of the enhanced image.

In a tenth aspect, alone or in combination with one or more of the first through ninth aspects, the computer vision model includes at least one of a convolutional neural network model, a noise reduction model, or a lookup model.

In an eleventh aspect, alone or in combination with one or more of the first through tenth aspects, the MBIR model includes a convolutional neural network that is trained to generate the enhanced image based at least in part on calibration information associated with the fingerprint scanner and an image quality associated with the image.

In a twelfth aspect, alone or in combination with one or more of the first through eleventh aspects, process 800 may include preprocessing the image to determine an image quality metric that is based at least in part on a quantity of noise in the image; and determining that the image quality metric does not satisfy a threshold quality, wherein the fingerprint scan data is processed based at least in part on determining that the image quality metric does not satisfy the threshold quality.

In a thirteenth aspect, alone or in combination with one or more of the first through twelfth aspects, the image is one of a plurality of images, and the fingerprint scan data corresponds to a fusion of the plurality of images.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

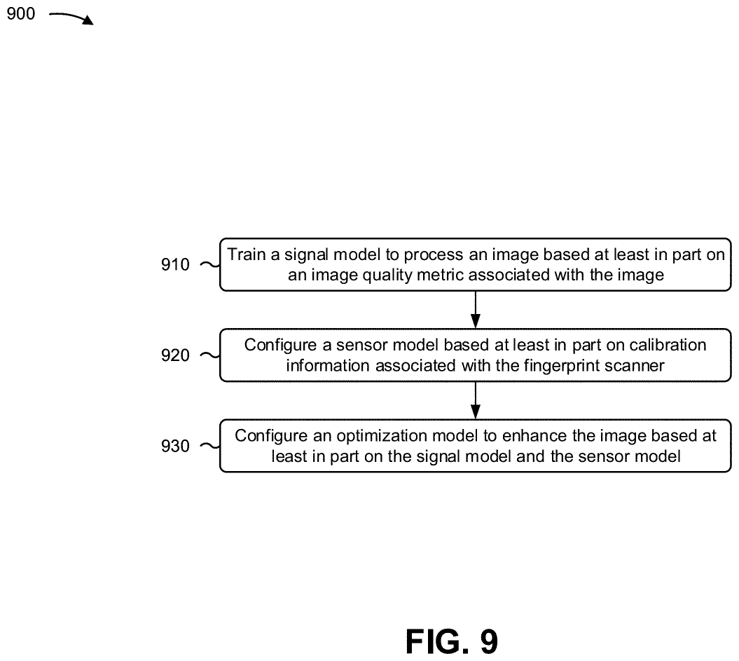

FIG. 9 is a diagram illustrating an example process 900 performed, for example, by a user device, in accordance with various aspects of the present disclosure. Example process 900 is an example where the user device (e.g., user device 110 and/or the like) utilizes MBIR for a fingerprint scanner.

As shown in FIG. 9, in some aspects, process 900 may include training a signal model to process an image based at least in part on an image quality metric associated with the image (block 910). For example, the user device (e.g., using processor 210, memory 215, storage component 220, input component 225, output component 230, communication interface 235, sensor 240, fingerprint scanner 245, and/or the like) may train a signal model to process an image based at least in part on an image quality metric associated with the image, as described above.

As further shown in FIG. 9, in some aspects, process 900 may include configuring a sensor model based at least in part on calibration information associated with the fingerprint scanner (block 920). For example, the user device (e.g., using processor 210, memory 215, storage component 220, input component 225, output component 230, communication interface 235, sensor 240, fingerprint scanner 245, and/or the like) may configure a sensor model based at least in part on calibration information associated with the fingerprint scanner, as described above.

As further shown in FIG. 9, in some aspects, process 900 may include configuring an optimization model to enhance the image based at least in part on the signal model and the sensor model (block 930). For example, the user device (e.g., using processor 210, memory 215, storage component 220, input component 225, output component 230, communication interface 235, sensor 240, fingerprint scanner 245, and/or the like) may configure an optimization model to enhance the image based at least in part on the signal model and the sensor model, as described above.

Process 900 may include additional aspects, such as any single aspect or any combination of aspects described below and/or in connection with one or more other processes described elsewhere herein.

In a first aspect, training the signal model may include receiving a plurality of training images that depict fingerprints; identifying, from the plurality of training images, training pixel arrays that each include pixels associated with depicting a portion of one of the fingerprints; designating individual center pixels of the training pixel arrays as corresponding reference pixels of the training pixel arrays; adding noise to the training pixel arrays to generate noisy pixel arrays; and training a convolutional neural network, associated with the signal model, using pairs of the noisy pixel arrays and the corresponding reference pixels.

In a second aspect, alone or in combination with the first aspect, configuring the sensor model may include obtaining the calibration information; determining point spread functions associated with sensing elements of the fingerprint scanner; and configuring the sensor model according to the point spread functions.

In a third aspect, alone or in combination with one or more of the first and second aspects, configuring the optimization model may include configuring a quantity of iterations to enhancing pixel values of the image based at least in part on an alternating direction method of multipliers model, and configuring the optimization model to provide an enhanced image associated with the image after the quantity of iterations are performed.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

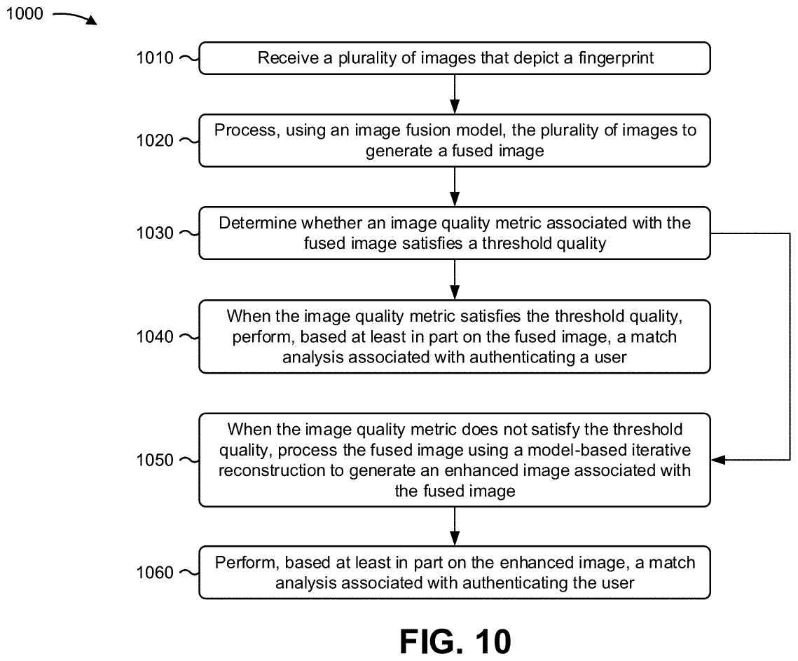

FIG. 10 is a diagram illustrating an example process 1000 performed, for example, by a user device, in accordance with various aspects of the present disclosure. Example process 1000 is an example where the user device (e.g., user device 110 and/or the like) utilizes MBIR for a fingerprint scanner.

As shown in FIG. 10, in some aspects, process 1000 may include receiving a plurality of images that depict a fingerprint (block 1010). For example, the user device (e.g., using processor 210, memory 215, storage component 220, input component 225, output component 230, communication interface 235, sensor 240, fingerprint scanner 245, and/or the like) may receive a plurality of images that depict a fingerprint, as described above.

As further shown in FIG. 10, in some aspects, process 1000 may include processing, using an image fusion model, the plurality of images to generate a fused image (block 1020). For example, the user device (e.g., using processor 210, memory 215, storage component 220, input component 225, output component 230, communication interface 235, sensor 240, fingerprint scanner 245, and/or the like) may process, using an image fusion model, the plurality of images to generate a fused image, as described above.

As further shown in FIG. 10, in some aspects, process 1000 may include determining whether an image quality metric associated with the fused image satisfies a threshold quality (block 1030). For example, the user device (e.g., using processor 210, memory 215, storage component 220, input component 225, output component 230, communication interface 235, sensor 240, fingerprint scanner 245, and/or the like) may determine whether an image quality metric associated with the fused image satisfies a threshold quality, as described above.

As further shown in FIG. 10, in some aspects, when the image quality metric satisfies the threshold quality, process 1000 may include performing, based at least in part on the fused image, a match analysis associated with authenticating a user (block 1040). For example, the user device (e.g., using processor 210, memory 215, storage component 220, input component 225, output component 230, communication interface 235, sensor 240, fingerprint scanner 245, and/or the like) may, when the image quality metric satisfies the threshold quality, perform, based at least in part on the fused image, a match analysis associated with authenticating a user, as described above.

As further shown in FIG. 10, in some aspects, when the image quality metric does not satisfy the threshold quality, process 1000 may include processing the fused image using a model-based iterative reconstruction to generate an enhanced image associated with the fused image (block 1050). For example, the user device (e.g., using processor 210, memory 215, storage component 220, input component 225, output component 230, communication interface 235, sensor 240, fingerprint scanner 245, and/or the like) may, when the image quality metric does not satisfy the threshold quality, process the fused image using a model-based iterative reconstruction to generate an enhanced image associated with the fused image, as described above.

As further shown in FIG. 10, in some aspects, process 1000 may include performing, based at least in part on the enhanced image, a match analysis associated with authenticating the user (block 1060). For example, the user device (e.g., using processor 210, memory 215, storage component 220, input component 225, output component 230, communication interface 235, sensor 240, fingerprint scanner 245, and/or the like) may perform, based at least in part on the enhanced image, a match analysis associated with authenticating the user, as described above.

Process 1000 may include additional aspects, such as any single aspect or any combination of aspects described below and/or in connection with one or more other processes described elsewhere herein.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

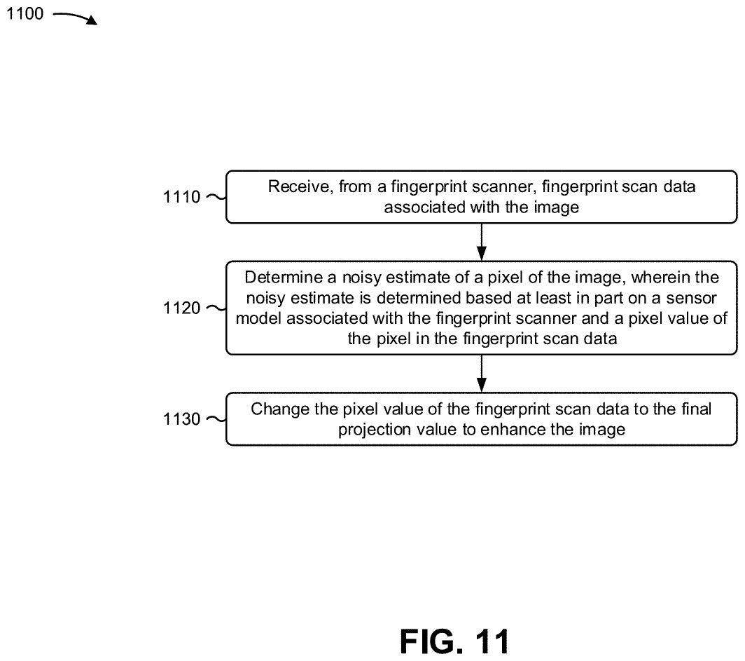

FIG. 11 is a diagram illustrating an example process 1100 performed, for example, by a user device, in accordance with various aspects of the present disclosure. Example process 1100 is an example where the user device (e.g., user device 110 and/or the like) utilizes MBIR for a fingerprint scanner.

As shown in FIG. 11, in some aspects, process 1100 may include receiving, from a fingerprint scanner, fingerprint scan data associated with the image (block 1110). For example, the user device (e.g., using processor 210, memory 215, storage component 220, input component 225, output component 230, communication interface 235, sensor 240, fingerprint scanner 245, and/or the like) may receive, from a fingerprint scanner, fingerprint scan data associated with the image, as described above.

As further shown in FIG. 11, in some aspects, process 1100 may include determining a noisy estimate of a pixel of the image, wherein the noisy estimate is determined based at least in part on a sensor model associated with the fingerprint scanner and a pixel value of the pixel in the fingerprint scan data (block 1120). For example, the user device (e.g., using processor 210, memory 215, storage component 220, input component 225, output component 230, communication interface 235, sensor 240, fingerprint scanner 245, and/or the like) may determine a noisy estimate of a pixel of the image, as described above. In some aspects, the noisy estimate is determined based at least in part on a sensor model associated with the fingerprint scanner and a pixel value of the pixel in the fingerprint scan data.

As further shown in FIG. 11, in some aspects, process 1100 may include changing the pixel value of the fingerprint scan data to the final projection value to enhance the image (block 1130). For example, the user device (e.g., using processor 210, memory 215, storage component 220, input component 225, output component 230, communication interface 235, sensor 240, fingerprint scanner 245, and/or the like) may change the pixel value of the fingerprint scan data to the final projection value to enhance the image, as described above.

Process 1100 may include additional aspects, such as any single aspect or any combination of aspects described below and/or in connection with one or more other processes described elsewhere herein.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

The foregoing disclosure provides illustration and description but is not intended to be exhaustive or to limit the aspects to the precise form disclosed. Modifications and variations may be made in light of the above disclosure or may be acquired from practice of the aspects.

As used herein, the term “component” is intended to be broadly construed as hardware, firmware, and/or a combination of hardware and software. As used herein, a processor is implemented in hardware, firmware, and/or a combination of hardware and software.

Some aspects are described herein in connection with thresholds. As used herein, satisfying a threshold may refer to a value being greater than the threshold, greater than or equal to the threshold, less than the threshold, less than or equal to the threshold, equal to the threshold, not equal to the threshold, and/or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” and/or the like are intended to be open-ended terms. Further, the phrase “based at least in part on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method, comprising:
receiving, by a device and from a fingerprint scanner, fingerprint scan data associated with an image that depicts a scanned fingerprint of a user;
processing, by the device and using a model-based iterative reconstruction (MBIR) model, the fingerprint scan data to generate an enhanced image associated with the image; and
performing, by the device and based at least in part on the enhanced image, a match analysis associated with authenticating the user.

2. The method of claim 1, wherein the fingerprint scanner includes an ultrasonic sensor and the fingerprint scan data is associated with an ultrasonic signal of the ultrasonic sensor.

3. The method of claim 1, wherein the fingerprint scanner includes an optical sensor and the fingerprint scan data is associated with an optical signal of the optical sensor.

4. The method of claim 1, wherein the MBIR model includes:
a sensor model that is configured according to calibration information of the fingerprint scanner, and
a signal model that is configured according to pixel values of the fingerprint scan data.

5. The method of claim 4, wherein processing the fingerprint scan data comprises, for a set of pixels of the image, iteratively:
determining an initial estimate for a pixel value, of the fingerprint scan data, that is associated with a pixel of the set of pixels; and
determining, for a quantity of iterations, projection estimates for the pixel value that is based at least in part on the initial estimate, the sensor model, and the signal model,
wherein a final projection estimate of a final iteration of the quantity of iterations corresponds to a final estimate for the pixel and is used to generate the enhanced image.

6. The method of claim 5, wherein the projection estimates are determined to be between a sensor pixel value defined by the sensor model and a signal pixel value defined by the signal model.

7. The method of claim 5, wherein the projection estimates are determined according to an alternating direction method of multipliers technique.

8. The method of claim 5, wherein the quantity of iterations is fixed.

9. The method of claim 5, wherein the quantity of iterations is based at least in part on an optimization model.

10. The method of claim 1, wherein the MBIR model includes:
a ridge regression model to determine initial noisy estimates for pixels of the image;
a computer vision model to determine, based at least in part on the initial noisy estimates and an image quality metric associated with the image, enhanced estimates for pixels of the image; and
an optimization model to determine, based at least in part on the enhanced estimates, final estimates for the pixels of the image that correspond to pixel values of the enhanced image.

11. The method of claim 10, wherein the computer vision model includes at least one of:
a convolutional neural network model,
a noise reduction model, or
a lookup model.

12. The method of claim 1, wherein the MBIR model includes a computer vision model that is trained to generate the enhanced image based at least in part on calibration information associated with the fingerprint scanner and an image quality associated with the image.

13. The method of claim 1, wherein the method further comprises:
preprocessing the image to determine an image quality metric that is based at least in part on a quantity of noise in the image; and
determining that the image quality metric does not satisfy a threshold quality,
wherein the fingerprint scan data is processed based at least in part on determining that the image quality metric does not satisfy the threshold quality.

14. The method of claim 1, wherein the image is one of a plurality of images, and the fingerprint scan data corresponds to a fusion of the plurality of images.

15. A device for wireless communication, comprising:
a memory; and
one or more processors operatively coupled to the memory, the memory and the one or more processors configured to:
train a signal model to process an image based at least in part on an image quality metric associated with the image;
configure a sensor model based at least in part on calibration information associated with a fingerprint scanner; and
configure an optimization model to enhance the image based at least in part on the signal model and the sensor model.

16. The device of claim 15, wherein the one or more processors, when training the signal model, are configure to:
receive a plurality of training images that depict fingerprints;
identify, from the plurality of training images, training pixel arrays that each include pixels associated with depicting a portion of one of the fingerprints;
designate individual center pixels of the training pixel arrays as corresponding reference pixels of the training pixel arrays;
add noise to the training pixel arrays to generate noisy pixel arrays; and
train a convolutional neural network, associated with the signal model, using pairs of the noisy pixel arrays and the corresponding reference pixels.

17. The device of claim 15, wherein the one or more processors, when configuring the sensor model, are configured to:
obtaining the calibration information;
determining point spread functions associated with sensing elements of the fingerprint scanner; and
configuring the sensor model according to the point spread functions.

18. The device of claim 15, wherein the one or more processors, when configuring the optimization model, are configured to:
configure a quantity of iterations to enhance pixel values of the image based at least in part on an alternating direction method of multipliers model; and
configure the optimization model to provide an enhanced image associated with the image after the quantity of iterations are performed.

19. A non-transitory computer-readable medium storing a set of instructions for wireless communication, the set of instructions comprising:
one or more instructions that, when executed by one or more processors of a device, cause the device to:
receive, from a fingerprint scanner, fingerprint scan data associated with an image that depicts a scanned fingerprint of a user;
process, using a model-based iterative reconstruction (MBIR) model, the fingerprint scan data to generate an enhanced image associated with the image; and
perform, based at least in part on the enhanced image, a match analysis associated with authenticating the user.

20. The non-transitory computer-readable medium of claim 19, wherein the MBIR model includes:
a sensor model that is configured according to calibration information of the fingerprint scanner, and
a signal model that is configured according to pixel values of the fingerprint scan data.

21. The non-transitory computer-readable medium of claim 20, wherein the one or more instructions, that cause the device to process the fingerprint scan data, cause the device to, for a set of pixels of the image, iteratively:
determine an initial estimate for a pixel value, of the fingerprint scan data, that is associated with a pixel of the set of pixels; and
determine, for a quantity of iterations, projection estimates for the pixel value that is based at least in part on the initial estimate, the sensor model, and the signal model,
wherein a final projection estimate of a final iteration of the quantity of iterations corresponds to a final estimate for the pixel and is used to generate the enhanced image.

22. The non-transitory computer-readable medium of claim 21, wherein the projection estimates are determined to be between a sensor pixel value defined by the sensor model and a signal pixel value defined by the signal model.

23. The non-transitory computer-readable medium of claim 21, wherein the projection estimates are determined according to an alternating direction method of multipliers technique.

24. The non-transitory computer-readable medium of claim 21, wherein the MBIR model includes:
a ridge regression model to determine initial noisy estimates for pixels of the image;
a computer vision model to determine, based at least in part on the initial noisy estimates and an image quality metric associated with the image, enhanced estimates for pixels of the image; and
an optimization model to determine, based at least in part on the enhanced estimates, final estimates for the pixels of the image that correspond to pixel values of the enhanced image.

25. An apparatus for wireless communication, comprising:
means for receiving, from a fingerprint scanner, fingerprint scan data associated with an image that depicts a scanned fingerprint of a user;
means for processing, using a model-based iterative reconstruction (MBIR) model, the fingerprint scan data to generate an enhanced image associated with the image; and
means for performing, based at least in part on the enhanced image, a match analysis associated with authenticating the user.

26. The apparatus of claim 25, wherein the MBIR model includes:
a sensor model that is configured according to calibration information of the fingerprint scanner, and
a signal model that is configured according to pixel values of the fingerprint scan data.

27. The apparatus of claim 26, wherein the means for processing the fingerprint scan data comprises, for a set of pixels of the image, iteratively:
means for determining an initial estimate for a pixel value, of the fingerprint scan data, that is associated with a pixel of the set of pixels; and
means for determining, for a quantity of iterations, projection estimates for the pixel value that is based at least in part on the initial estimate, the sensor model, and the signal model,
wherein a final projection estimate of a final iteration of the quantity of iterations corresponds to a final estimate for the pixel and is used to generate the enhanced image.

28. The apparatus of claim 27, wherein the projection estimates are determined to be between a sensor pixel value defined by the sensor model and a signal pixel value defined by the signal model.

29. The apparatus of claim 27, wherein the projection estimates are determined according to an alternating direction method of multipliers technique.

30. The apparatus of claim 27, wherein the MBIR model includes:
a ridge regression model to determine initial noisy estimates for pixels of the image;
a computer vision model to determine, based at least in part on the initial noisy estimates and an image quality metric associated with the image, enhanced estimates for pixels of the image; and
an optimization model to determine, based at least in part on the enhanced estimates, final estimates for the pixels of the image that correspond to pixel values of the enhanced image.
